(19) United States
(12) Patent Application Publication
(10) Pub. No.: US 2022/0327797 A1
(43) Pub. Date: Oct. 13, 2022

(54) Processing Regions Of A Video

(71) Applicant: Meta Platforms, Inc., Menlo Park, CA (US)

(72) Inventors: Iulian Doroftei Calinov, Sammamish, WA (US); Marek F. Latuskiewicz, Clyde Hill, WA (US); Mayank Singh Chaudhary, Palo Alto, CA (US); Meng Zhang, Los Altos, CA (US); Sergey Sablin, Redmond, WA (US); Xingze He, Sunnyvale, CA (US); Yu-Chen Sun, Bellevue, WA (US); Yun Zhang, Newark, CA (US); Addie Louise Marino, Brooklyn, NY (US); Miguel Angel Perez, Brooklyn, NY (US)

(21) Appl. No.: 17/713,898

(22) Filed: Apr. 5, 2022

Related U.S. Application Data
(60) Provisional application No. 63/173,957, filed on Apr. 12, 2021.
(60) Provisional application No. 63/175,336, filed on Apr. 15, 2021.

(51) Int. Cl. G06V 10/25; G06V 40/16; G06F 16/78

(52) U.S. Cl. CPC G06V 10/25; G06V 40/16; G06F 16/78

(57) ABSTRACT

A method includes optimizing a video quality of a video data stream received by a user in a video conference. A region of at least one frame of the video data stream may be sampled. The sampling rate may be variable based on the rate of change of objects in the video data stream. A video quality metric corresponding to the video quality of the video data stream may be calculated. The video quality of the video data stream may be adjusted based on the video quality metric. Another method includes retrieving a video and detecting one or more moving regions of interest (ROIs). Each of the ROIs is tagged with metadata configured to allow users to interact with the ROI, and the detected ROIs and their corresponding metadata are stored in a file. Based on the file, playback of the video and movement of the ROIs may be synchronized.

### PRIORITY

This application claims the benefit under 35 U.S.C. § 119(e) of U.S. Provisional Patent Application No. 63/173,957, filed 12 Apr. 2021 and U.S. Provisional Patent Application No. 63/175,336, filed 15 Apr. 2021, which are incorporated herein by reference.

### TECHNICAL FIELD

This disclosure generally relates to processing a video.

### BRIEF DESCRIPTION OF THE DRAWINGS

FIG. 11 illustrates an example method for optimizing video quality for video conferencing.

FIG. 21 illustrates an example architecture for converting ROIs in video content into interactive surfaces with which a user may interact.

FIG. 22 illustrates an example method for enabling a user to interact with particular ROIs in video content.

FIG. 23 illustrates an example network environment associated with a social-networking system.

FIG. 24 illustrates an example social graph.

FIG. 25 illustrates an example computer system.

### DESCRIPTION OF EXAMPLE EMBODIMENTS (VIDEO QUALITY MEASUREMENT OPTIMIZATIONS)

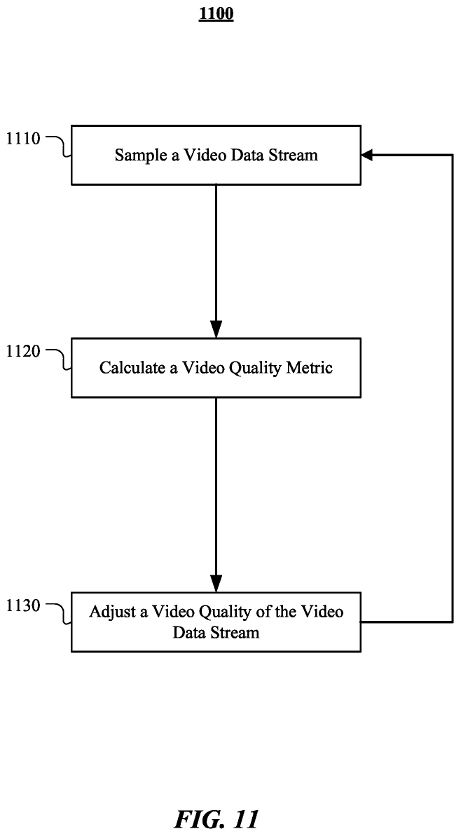

FIG. 11 illustrates an example method 1100 for optimizing video quality for video conferencing.

The method may begin at step 1110, where a video data stream may be sampled as it is being received or output by a computing device of a user. At step 1120, a video quality metric may be calculated, wherein the video quality metric corresponds to a video quality of the video data stream. At step 1130, the video quality of the video data stream may be adjusted based on the value of the video quality metric. The method may then continue by sampling the video data stream as it is being transmitted to the computing device of the user at step 1110. Particular embodiments may repeat one or more steps of the method of FIG. 11, where appropriate. Although this disclosure describes and illustrates particular steps of the method of FIG. 11 as occurring in a particular order, this disclosure contemplates any suitable steps of the method of FIG. 11 occurring in any suitable order. Moreover, although this disclosure describes and illustrates an example method for optimizing video quality for video conferencing including the particular steps of the method of FIG. 11, this disclosure contemplates any suitable method for optimizing video quality for video conferencing including any suitable steps, which may include all, some, or none of the steps of the method of FIG. 11, where appropriate. Furthermore, although this disclosure describes and illustrates particular components, devices, or systems carrying out particular steps of the method of FIG. 11, this disclosure contemplates any suitable combination of any suitable components, devices, or systems carrying out any suitable steps of the method of FIG. 11.

In particular embodiments, sampling the video data stream at step 1110 comprises sampling only image data corresponding to a selected region of the video data stream. The selected region may be associated with at least one of a focus point identified in the video data stream, a face identified in the video data stream, or a segment of the video data stream identified as a foreground. Such contextual spatial sampling of video data may be used to optimize video quality measurements. By restricting the surface area of video processing only to relevant parts of the video, there may be a very significant reduction of computing resources allocated to measuring quality, minimizing degradation of perceived quality by the user.

In particular embodiments, the region selected to sample from at step 1110 may be associated with a focus point identified in the video data stream. The focus of the camera of another participant in a video conference (a “sender”) may be the center of the image, and that point may be selected as a focus point of the user. In other embodiments, an autofocus system of the sender's camera may provide information about the focus of the sender's camera, informing the selection of a focus point of the user. In these embodiments, the point of focus information is sent to the user, and the user/client may evaluate the video quality in a region surrounding the point of focus (e.g., the region may be a circle of a predetermined size centered at the focus point). In other embodiments, a camera of the user estimates where the user is looking (e.g., whether the user is looking at the top of the video, the bottom of the video, etc.) and uses that information to select a focus point at step 1110.

In particular embodiments, the region selected to sample from at step 1110 may be associated with a face identified in the video data stream. Any face-detection technique may be used to identify a face. The face-detection technique could be an ML model trained to recognize faces in an image. The output of the ML model may be a “segmentation mask” that identifies which pixels in the image correspond to a person's face. That segmentation mask may be computed on the sender side or the user side. The user/client may compute the segmentation mask or receive it from the sender and only evaluate the portions of the video within the segmentation mask.

In particular embodiments, the region selected to sample from at step 1110 may be associated with a segment of the video data stream identified as foreground. An ML model may similarly be used to filter out the rest of the image, or the rest of the non-face area of the image.

In particular embodiments, sampling the video data stream at step 1110 comprises using a variable sampling rate correlated with a rate of change of the image data. An optimal and variable sampling rate correlates with how fast the relevant aspects of the video are changing. Consecutive samples of image data may be compared. If the image data is changing significantly from sample to sample, then the sample rate may be increased. If the image data is not changing significantly from sample to sample, then the sample rate may be decreased. This variable sampling rate may be informed by experimentation data that correlates perceived video quality with temporal sampling rate.

In particular embodiments, calculating a video quality metric at step 1120 comprises using an ML Model or DNN. An ML model may be trained to take the sampled image data from the video data stream as described above as input and output a metric that reflects the quality of the video. Before the ML is used, it may need to be trained. For example, the ML model may be trained using thousands of training data sets. During each training iteration, the ML model may process a training data set, which includes a sequence of sampled images. The ML model may then output a video quality metric. That video quality metric, during training, may be compared to an actual score that a human provided, or the score may be generated using traditional, expensive methods (ground truth). The resulting score comparisons may be “back propagated” and used to update the ML model so that the ML model may perform better in the next iteration of the training. This process may continue until the training samples are exhausted or the difference between the ML-generated score and the “ground truth” is sufficiently small. Once trained, the ML model may be downloaded by the user/client and used to quickly evaluate video quality.

### Description of Example Embodiments (Interactive Video)

In particular embodiments, a social-networking system may enable a user to interact with particular ROIs in a piece of video content. When users view video content, it is typically a passive experience. However, by assisting content providers in transforming their video content into interactive surfaces, the viewing experience of the users may become more immersive, and the ability of the content providers to reach and connect with these users may be expanded. Transforming video content into interactive content may involve tracking moving objects or ROIs within a video and tagging them with metadata. These ROIs may then be selectable during video playback, thus allowing users to interact with the ROIs any time they are visible within the video.

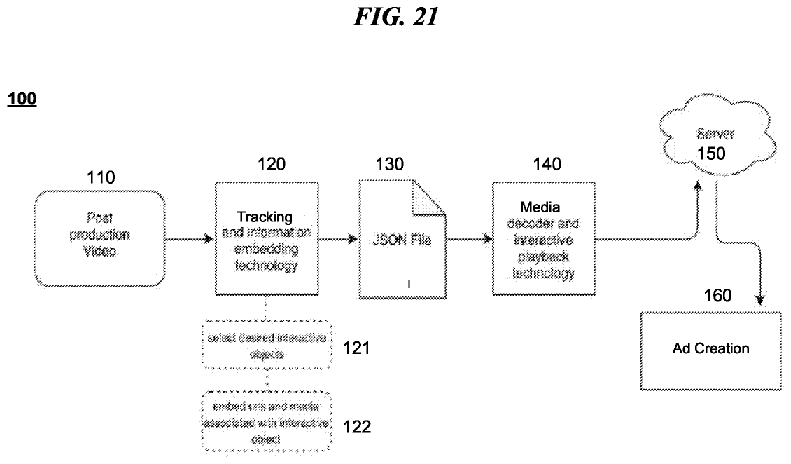

FIG. 21 illustrates an example architecture 100 for converting ROIs in video content into interactive surfaces with which a user may interact. In particular embodiments, a video may initially be retrieved. As an example, a video may be retrieved from a remote server. However, as another example, a recently created video may be retrieved from local storage. Subsequently, one or more moving ROIs may be detected within the video, and each of the ROIs may be tagged with metadata configured to allow users to interact with the ROI. For example, content creators may track objects within a video using, for example, a post production video tool 110. In particular embodiments, the post production video tool 110 may be used by a content creator to manually tag objects to be tracked and then tag these objects with particular data. Such tagged objects may be referred to as “hotspots”. Tracking and information embedding technology tool 120 may serve as an editor to select desired interactive objects or areas at function 121. These objects or areas may then be tracked within video scenes using, for example, computer vision techniques. As an example, one such computer vision technique may include calculating the mean-shift of a moving object. Once the desired objects are tracked, at function 122, content creators may use the editor 120 to assign metadata to the tracked object or area in the video scene, thus making the object available for users to interact with. As examples, such metadata may include an image, additional video content, text data, HTML, or a URL, which may direct a user to a website or a game associated with the tagged object. Finally, after generating the hotspots or tagged moving objects, the detected one or more ROIs and their corresponding metadata may be stored in a file. In particular embodiments, this data may be exported as a file 130, such as a .JSON file.

Media decoder and interactive playback technology tool 140 may then visualize the hotspots and make them selectable by a user by augmenting the video with the interactive content decoded from the hotspot data. In particular embodiments, tool 140 may include a script that decodes the file (e.g., the JSON file). Then, based on the file, playback of the video and movement of the one or more ROIs may be synchronized. The script may then synchronize the playback of the video and the hotspot data associated with the tracked objects and their tagged metadata. As an example, such synchronization of the video and the hotspots may be scripted in a similar fashion to the interpretation and rendering of synchronized subtitles or closed captions within a video from files (e.g., .srt or .sbv files). This script may then visualize the hotspots available during video playback and monitor for any user touch or clicking events within a video scene. In particular embodiments, the script may receive, from a client device of a user, user selection of a first ROI from among the one or more ROIs. When the user selects a region associated with a hotspot, the script may then retrieve content associated with the first ROI based on the tagged metadata of the first ROI and load the tagged content associated with this selected hotspot. In particular embodiments, the script may pause playback of the video to present this content; however, in other embodiments, the content may be displayed while playback of the video continues.

During media playback, rendered content loaded from the .json file may be overlaid on the video when user interaction (e.g., a touch interaction) is detected on the screen of a user device. Both video and interactive hotspots may be played back, and content delivery of the tagged data may be based on the type of the metadata that the hotspot is tagged with. Thus, the presented tagged content or metadata may be visualized within a video scene in varying ways depending on its format. In particular embodiments, the tagged data associated with a moving object may include an image, additional video content, text data, HTML, or a URL. If the tagged data is HTML or a URL, it may be overlaid on the hotspot in a window, thus rendering content over the video itself. If the tagged data is a video, this video element may be loaded over the hotspot in a window, and this overlaid video may be rendered with its own set of interactive playback controllers within the window. If the tagged data is image or text data, this data may be rendered in a window overlaid on the video. Then, instructions to present the retrieved content in the appropriate format may be sent to the client system.

Such video enhancement may be used in various settings. As an example, the video may be used in advertising, and once the video and hotspots have been synchronized, it may be uploaded to server 150 or sent to ad creation 160 for display on a social-networking site. Such an advertisement may be a short video associated with a fitness company. At points throughout the video, hotspots may appear on products, games, or people appearing within the video. A user viewing this video may then tap the hotspots to be immersed deeper in the experience, thus allowing the user to shop, play a game, or watch additional content related to the current video. As another example, such video enhancement may be used in a 3D environment of a video game, with the hotspots overlaid on the video itself.

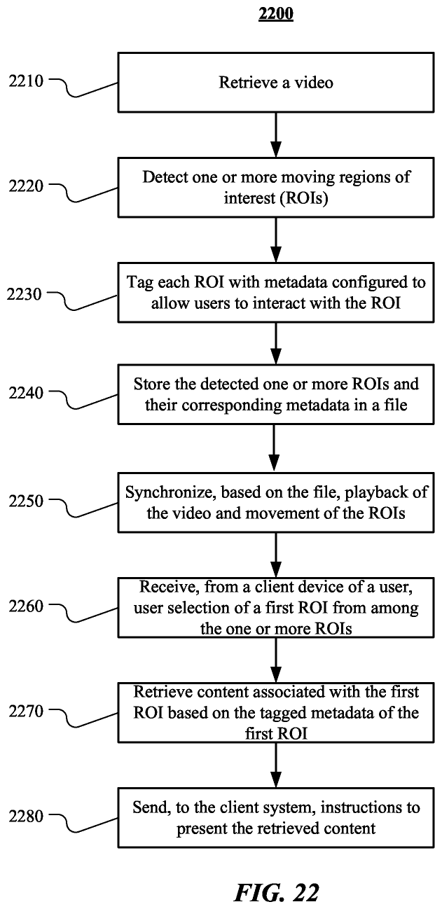

FIG. 22 illustrates an example method 2200 for method for enabling a user to interact with particular ROIs in video content. The method may begin at step 2210, where a video is retrieved. At step 2220, one or more moving ROIs are detected. At step 2230, each of the ROIs may be tagged with metadata configured to allow users to interact with the ROI, and at step 2240, the detected one or more ROIs and their corresponding metadata may be stored in a file. Particular embodiments may repeat one or more steps of the method of FIG. 22, where appropriate. At step 2250, based on the file, playback of the video and movement of the one or more ROIs may be synchronized. Then, at step 2260, a user selection of a first ROI from among the one or more ROIs may be received from a client device of a user. At step 2270, content associated with the first ROI may be retrieved based on the tagged metadata of the first ROI. Finally, at step 2280, the method may send, to the client system, instructions to present the retrieved content. Although this disclosure describes and illustrates particular steps of the method of FIG. 22 as occurring in a particular order, this disclosure contemplates any suitable steps of the method of FIG. 22 occurring in any suitable order. Moreover, although this disclosure describes and illustrates an example method for method for enabling a user to interact with particular ROIs in video content including the particular steps of the method of FIG. 22, this disclosure contemplates any suitable method for method for enabling a user to interact with particular ROIs in video content including any suitable steps, which may include all, some, or none of the steps of the method of FIG. 22, where appropriate. Furthermore, although this disclosure describes and illustrates particular components, devices, or systems carrying out particular steps of the method of FIG. 22, this disclosure contemplates any suitable combination of any suitable components, devices, or systems carrying out any suitable steps of the method of FIG. 22.

### System Overview

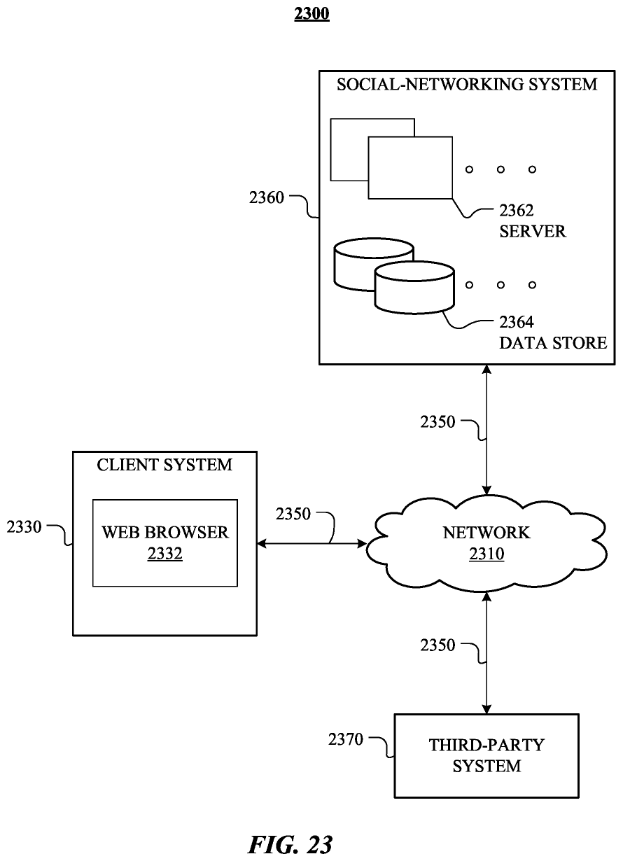

FIG. 23 illustrates an example network environment 2300 associated with a social-networking system. Network environment 2300 includes a client system 2330, a social-networking system 2360, and a third-party system 2370 connected to each other by a network 2310. Although FIG. 23 illustrates a particular arrangement of client system 2330, social-networking system 2360, third-party system 2370, and network 2310, this disclosure contemplates any suitable arrangement of client system 2330, social-networking system 2360, third-party system 2370, and network 2310. As an example and not by way of limitation, two or more of client system 2330, social-networking system 2360, and third-party system 2370 may be connected to each other directly, bypassing network 2310. As another example, two or more of client system 2330, social-networking system 2360, and third-party system 2370 may be physically or logically co-located with each other in whole or in part. Moreover, although FIG. 23 illustrates a particular number of client systems 2330, social-networking systems 2360, third-party systems 2370, and networks 2310, this disclosure contemplates any suitable number of client systems 2330, social-networking systems 2360, third-party systems 2370, and networks 2310. As an example and not by way of limitation, network environment 2300 may include multiple client system 2330, social-networking systems 2360, third-party systems 2370, and networks 2310.

This disclosure contemplates any suitable network 2310. As an example and not by way of limitation, one or more portions of network 2310 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 2310 may include one or more networks 2310.

Links 2350 may connect client system 2330, social-networking system 2360, and third-party system 2370 to communication network 2310 or to each other. This disclosure contemplates any suitable links 2350. In particular embodiments, one or more links 2350 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 2350 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 2350, or a combination of two or more such links 2350. Links 2350 need not necessarily be the same throughout network environment 2300. One or more first links 2350 may differ in one or more respects from one or more second links 2350.

In particular embodiments, client system 2330 may be an electronic device including hardware, software, or embedded logic components or a combination of two or more such components and capable of carrying out the appropriate functionalities implemented or supported by client system 2330. As an example and not by way of limitation, a client system 2330 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 2330. A client system 2330 may enable a network user at client system 2330 to access network 2310. A client system 2330 may enable its user to communicate with other users at other client systems 2330.

In particular embodiments, client system 2330 may include a web browser 2332, and may have one or more add-ons, plug-ins, or other extensions. A user at client system 2330 may enter a Uniform Resource Locator (URL) or other address directing the web browser 2332 to a particular server (such as server 2362, or a server associated with a third-party system 2370), and the web browser 2332 may generate a Hyper Text Transfer Protocol (HTTP) request and communicate the HTTP request to server. The server may accept the HTTP request and communicate to client system 2330 one or more Hyper Text Markup Language (HTML) files responsive to the HTTP request. Client system 2330 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts, combinations of markup language and scripts, and the like. Herein, reference to a webpage encompasses one or more corresponding webpage files (which a browser may use to render the webpage) and vice versa, where appropriate.

In particular embodiments, social-networking system 2360 may be a network-addressable computing system that can host an online social network. Social-networking system 2360 may generate, store, receive, and send social-networking data, such as, for example, user-profile data, concept-profile data, social-graph information, or other suitable data related to the online social network. Social-networking system 2360 may be accessed by the other components of network environment 2300 either directly or via network 2310. As an example and not by way of limitation, client system 2330 may access social-networking system 2360 using a web browser 2332, or a native application associated with social-networking system 2360 (e.g., a mobile social-networking application, a messaging application, another suitable application, or any combination thereof) either directly or via network 2310. In particular embodiments, social-networking system 2360 may include one or more servers 2362. Each server 2362 may be a unitary server or a distributed server spanning multiple computers or multiple datacenters. Servers 2362 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 2362 may include hardware, software, or embedded logic components or a combination of two or more such components for carrying out the appropriate functionalities implemented or supported by server 2362. In particular embodiments, social-networking system 2360 may include one or more data stores 2364. Data stores 2364 may be used to store various types of information. In particular embodiments, the information stored in data stores 2364 may be organized according to specific data structures. In particular embodiments, each data store 2364 may be a relational, columnar, correlation, or other suitable database. Although this disclosure describes or illustrates particular types of databases, this disclosure contemplates any suitable types of databases. Particular embodiments may provide interfaces that enable a client system 2330, a social-networking system 2360, or a third-party system 2370 to manage, retrieve, modify, add, or delete, the information stored in data store 2364.

In particular embodiments, social-networking system 2360 may store one or more social graphs in one or more data stores 2364. In particular embodiments, a social graph may include multiple nodes—which may include multiple user nodes (each corresponding to a particular user) or multiple concept nodes (each corresponding to a particular concept)—and multiple edges connecting the nodes. Social-networking system 2360 may provide users of the online social network the ability to communicate and interact with other users. In particular embodiments, users may join the online social network via social-networking system 2360 and then add connections (e.g., relationships) to a number of other users of social-networking system 2360 to whom they want to be connected. Herein, the term “friend” may refer to any other user of social-networking system 2360 with whom a user has formed a connection, association, or relationship via social-networking system 2360.

In particular embodiments, social-networking system 2360 may provide users with the ability to take actions on various types of items or objects, supported by social-networking system 2360. As an example and not by way of limitation, the items and objects may include groups or social networks to which users of social-networking system 2360 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 2360 or by an external system of third-party system 2370, which is separate from social-networking system 2360 and coupled to social-networking system 2360 via a network 2310.

In particular embodiments, social-networking system 2360 may be capable of linking a variety of entities. As an example and not by way of limitation, social-networking system 2360 may enable users to interact with each other as well as receive content from third-party systems 2370 or other entities, or to allow users to interact with these entities through an application programming interfaces (API) or other communication channels.

In particular embodiments, a third-party system 2370 may include one or more types of servers, one or more data stores, one or more interfaces, including but not limited to APIs, one or more web services, one or more content sources, one or more networks, or any other suitable components, e.g., that servers may communicate with. A third-party system 2370 may be operated by a different entity from an entity operating social-networking system 2360. In particular embodiments, however, social-networking system 2360 and third-party systems 2370 may operate in conjunction with each other to provide social-networking services to users of social-networking system 2360 or third-party systems 2370. In this sense, social-networking system 2360 may provide a platform, or backbone, which other systems, such as third-party systems 2370, may use to provide social-networking services and functionality to users across the Internet.

In particular embodiments, a third-party system 2370 may include a third-party content object provider. A third-party content object provider may include one or more sources of content objects, which may be communicated to a client system 2330. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 2360 also includes user-generated content objects, which may enhance a user's interactions with social-networking system 2360. User-generated content may include anything a user can add, upload, send, or “post” to social-networking system 2360. As an example and not by way of limitation, a user communicates posts to social-networking system 2360 from a client system 2330. Posts may include data such as status updates or other textual data, location information, photos, videos, links, music or other similar data or media. Content may also be added to social-networking system 2360 by a third-party through a “communication channel,” such as a newsfeed or stream.

In particular embodiments, social-networking system 2360 may include a variety of servers, sub-systems, programs, modules, logs, and data stores. In particular embodiments, social-networking system 2360 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 2360 may also include suitable components such as network interfaces, security mechanisms, load balancers, failover servers, management-and-network-operations consoles, other suitable components, or any suitable combination thereof. In particular embodiments, social-networking system 2360 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 2360 to one or more client systems 2330 or one or more third-party system 2370 via network 2310. The web server may include a mail server or other messaging functionality for receiving and routing messages between social-networking system 2360 and one or more client systems 2330. An API-request server may allow a third-party system 2370 to access information from social-networking system 2360 by calling one or more APIs. An action logger may be used to receive communications from a web server about a user's actions on or off social-networking system 2360. In conjunction with the action log, a third-party-content-object log may be maintained of user exposures to third-party-content objects. A notification controller may provide information regarding content objects to a client system 2330. Information may be pushed to a client system 2330 as notifications, or information may be pulled from client system 2330 responsive to a request received from client system 2330. Authorization servers may be used to enforce one or more privacy settings of the users of social-networking system 2360. A privacy setting of a user determines how particular information associated with a user can be shared. The authorization server may allow users to opt in to or opt out of having their actions logged by social-networking system 2360 or shared with other systems (e.g., third-party system 2370), such as, for example, by setting appropriate privacy settings. Third-party-content-object stores may be used to store content objects received from third parties, such as a third-party system 2370. Location stores may be used for storing location information received from client systems 2330 associated with users. Advertisement-pricing modules may combine social information, the current time, location information, or other suitable information to provide relevant advertisements, in the form of notifications, to a user.

### Social Graphs

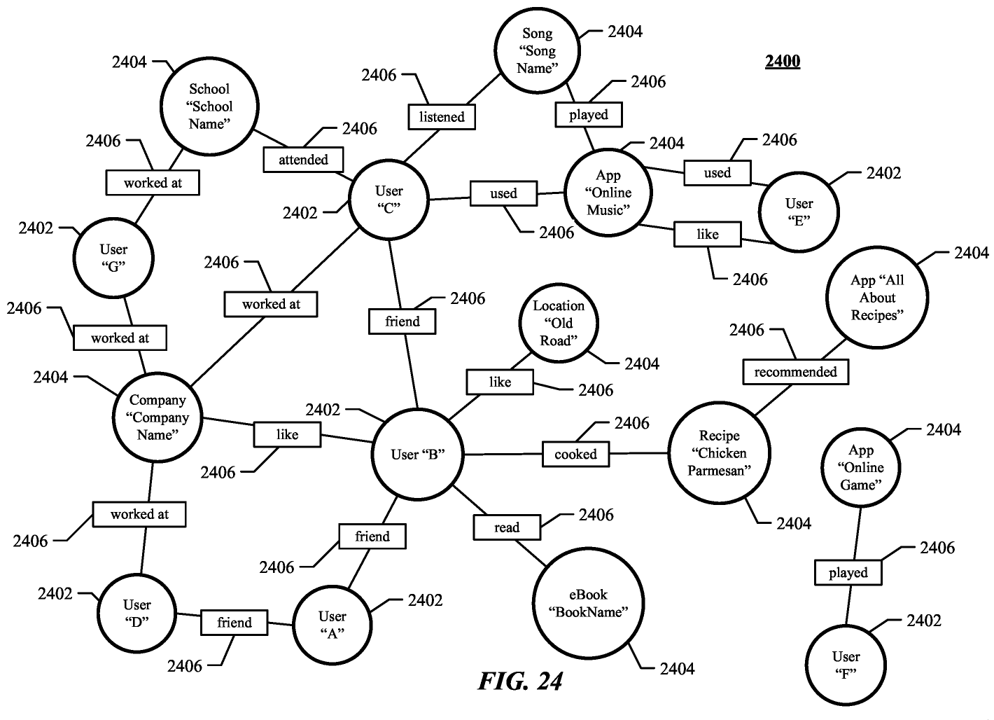

FIG. 24 illustrates example social graph 2400. In particular embodiments, social-networking system 2360 may store one or more social graphs 2400 in one or more data stores. In particular embodiments, social graph 2400 may include multiple nodes—which may include multiple user nodes 2402 or multiple concept nodes 2404—and multiple edges 2406 connecting the nodes. Each node may be associated with a unique entity (i.e., user or concept), each of which may have a unique identifier (ID), such as a unique number or username. Example social graph 2400 illustrated in FIG. 24 is shown, for didactic purposes, in a two-dimensional visual map representation. In particular embodiments, a social-networking system 2360, client system 2330, or third-party system 2370 may access social graph 2400 and related social-graph information for suitable applications. The nodes and edges of social graph 2400 may be stored as data objects, for example, in a data store (such as a social-graph database). Such a data store may include one or more searchable or queryable indexes of nodes or edges of social graph 2400.

In particular embodiments, a user node 2402 may correspond to a user of social-networking system 2360. As an example and not by way of limitation, a user may be an individual (human user), an entity (e.g., an enterprise, business, or third-party application), or a group (e.g., of individuals or entities) that interacts or communicates with or over social-networking system 2360. In particular embodiments, when a user registers for an account with social-networking system 2360, social-networking system 2360 may create a user node 2402 corresponding to the user, and store the user node 2402 in one or more data stores. Users and user nodes 2402 described herein may, where appropriate, refer to registered users and user nodes 2402 associated with registered users. In addition or as an alternative, users and user nodes 2402 described herein may, where appropriate, refer to users that have not registered with social-networking system 2360. In particular embodiments, a user node 2402 may be associated with information provided by a user or information gathered by various systems, including social-networking system 2360. As an example and not by way of limitation, a user may provide his or her name, profile picture, contact information, birth date, sex, marital status, family status, employment, education background, preferences, interests, or other demographic information. In particular embodiments, a user node 2402 may be associated with one or more data objects corresponding to information associated with a user. In particular embodiments, a user node 2402 may correspond to one or more webpages.

In particular embodiments, a concept node 2404 may correspond to a concept. As an example and not by way of limitation, a concept may correspond to a place (such as, for example, a movie theater, restaurant, landmark, or city); a website (such as, for example, a website associated with social-network system 2360 or a third-party website associated with a web-application server); an entity (such as, for example, a person, business, group, sports team, or celebrity); a resource (such as, for example, an audio file, video file, digital photo, text file, structured document, or application) which may be located within social-networking system 2360 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 2404 may be associated with information of a concept provided by a user or information gathered by various systems, including social-networking system 2360. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 2404 may be associated with one or more data objects corresponding to information associated with concept node 2404. In particular embodiments, a concept node 2404 may correspond to one or more webpages.

In particular embodiments, a node in social graph 2400 may represent or be represented by a webpage (which may be referred to as a “profile page”). Profile pages may be hosted by or accessible to social-networking system 2360. Profile pages may also be hosted on third-party websites associated with a third-party system 2370. As an example and not by way of limitation, a profile page corresponding to a particular external webpage may be the particular external webpage and the profile page may correspond to a particular concept node 2404. Profile pages may be viewable by all or a selected subset of other users. As an example and not by way of limitation, a user node 2402 may have a corresponding user-profile page in which the corresponding user may add content, make declarations, or otherwise express himself or herself. As another example and not by way of limitation, a concept node 2404 may have a corresponding concept-profile page in which one or more users may add content, make declarations, or express themselves, particularly in relation to the concept corresponding to concept node 2404.

In particular embodiments, a concept node 2404 may represent a third-party webpage or resource hosted by a third-party system 2370. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 2330 to send to social-networking system 2360 a message indicating the user's action. In response to the message, social-networking system 2360 may create an edge (e.g., a check-in-type edge) between a user node 2402 corresponding to the user and a concept node 2404 corresponding to the third-party webpage or resource and store edge 2406 in one or more data stores.

In particular embodiments, a pair of nodes in social graph 2400 may be connected to each other by one or more edges 2406. An edge 2406 connecting a pair of nodes may represent a relationship between the pair of nodes. In particular embodiments, an edge 2406 may include or represent one or more data objects or attributes corresponding to the relationship between a pair of nodes. As an example and not by way of limitation, a first user may indicate that a second user is a “friend” of the first user. In response to this indication, social-networking system 2360 may send a “friend request” to the second user. If the second user confirms the “friend request,” social-networking system 2360 may create an edge 2406 connecting the first user's user node 2402 to the second user's user node 2402 in social graph 2400 and store edge 2406 as social-graph information in one or more of data stores 2364. In the example of FIG. 24, social graph 2400 includes an edge 2406 indicating a friend relation between user nodes 2402 of user “A” and user “B” and an edge indicating a friend relation between user nodes 2402 of user “C” and user “B.” Although this disclosure describes or illustrates particular edges 2406 with particular attributes connecting particular user nodes 2402, this disclosure contemplates any suitable edges 2406 with any suitable attributes connecting user nodes 2402. As an example and not by way of limitation, an edge 2406 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 2400 by one or more edges 2406. The degree of separation between two objects represented by two nodes, respectively, is a count of edges in a shortest path connecting the two nodes in the social graph 2400. As an example and not by way of limitation, in the social graph 2400, the user node 2402 of user “C” is connected to the user node 2402 of user “A” via multiple paths including, for example, a first path directly passing through the user node 2402 of user “B,” a second path passing through the concept node 2404 of company “CompanyName” and the user node 2402 of user “D,” and a third path passing through the user nodes 2402 and concept nodes 2404 representing school “SchoolName,” user “G,” company “CompanyName,” and user “D.” User “C” and user “A” have a degree of separation of two because the shortest path connecting their corresponding nodes (i.e., the first path) includes two edges 2406.

In particular embodiments, an edge 2406 between a user node 2402 and a concept node 2404 may represent a particular action or activity performed by a user associated with user node 2402 toward a concept associated with a concept node 2404. As an example and not by way of limitation, as illustrated in FIG. 24, a user may “like,” “attended,” “played,” “listened,” “cooked,” “worked at,” or “watched” a concept, each of which may correspond to an edge type or subtype. A concept-profile page corresponding to a concept node 2404 may include, for example, a selectable “check in” icon (such as, for example, a clickable “check in” icon) or a selectable “add to favorites” icon. Similarly, after a user clicks these icons, social-networking system 2360 may create a “favorite” edge or a “check in” edge in response to a user's action corresponding to a respective action. As another example and not by way of limitation, a user (user “C”) may listen to a particular song (“SongName”) using a particular application (a third-party online music application). In this case, social-networking system 2360 may create a “listened” edge 2406 and a “used” edge (as illustrated in FIG. 24) between user nodes 2402 corresponding to the user and concept nodes 2404 corresponding to the song and application to indicate that the user listened to the song and used the application. Moreover, social-networking system 2360 may create a “played” edge 2406 (as illustrated in FIG. 24) between concept nodes 2404 corresponding to the song and the application to indicate that the particular song was played by the particular application. In this case, “played” edge 2406 corresponds to an action performed by an external application (the third-party online music application) on an external audio file (the song “SongName”). Although this disclosure describes particular edges 2406 with particular attributes connecting user nodes 2402 and concept nodes 2404, this disclosure contemplates any suitable edges 2406 with any suitable attributes connecting user nodes 2402 and concept nodes 2404. Moreover, although this disclosure describes edges between a user node 2402 and a concept node 2404 representing a single relationship, this disclosure contemplates edges between a user node 2402 and a concept node 2404 representing one or more relationships. As an example and not by way of limitation, an edge 2406 may represent both that a user likes and has used at a particular concept. Alternatively, another edge 2406 may represent each type of relationship (or multiples of a single relationship) between a user node 2402 and a concept node 2404 (as illustrated in FIG. 24 between user node 2402 for user “E” and concept node 2404 for “online music application”).

In particular embodiments, social-networking system 2360 may create an edge 2406 between a user node 2402 and a concept node 2404 in social graph 2400. As an example and not by way of limitation, a user viewing a concept-profile page (such as, for example, by using a web browser or a special-purpose application hosted by the user's client system 2330) may indicate that he or she likes the concept represented by the concept node 2404 by clicking or selecting a “Like” icon, which may cause the user's client system 2330 to send to social-networking system 2360 a message indicating the user's liking of the concept associated with the concept-profile page. In response to the message, social-networking system 2360 may create an edge 2406 between user node 2402 associated with the user and concept node 2404, as illustrated by “like” edge 2406 between the user and concept node 2404. In particular embodiments, social-networking system 2360 may store an edge 2406 in one or more data stores. In particular embodiments, an edge 2406 may be automatically formed by social-networking system 2360 in response to a particular user action. As an example and not by way of limitation, if a first user uploads a picture, watches a movie, or listens to a song, an edge 2406 may be formed between user node 2402 corresponding to the first user and concept nodes 2404 corresponding to those concepts. Although this disclosure describes forming particular edges 2406 in particular manners, this disclosure contemplates forming any suitable edges 2406 in any suitable manner.

### Advertising

In particular embodiments, an advertisement may be text (which may be HTML-linked), one or more images (which may be HTML-linked), one or more videos, audio, other suitable digital object files, a suitable combination of these, or any other suitable advertisement in any suitable digital format presented on one or more web pages, in one or more e-mails, or in connection with search results requested by a user. In addition or as an alternative, an advertisement may be one or more sponsored stories (e.g., a news-feed or ticker item on social-networking system 2360). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. The social action may be promoted within or on social-networking system 2360. In addition or as an alternative, the social action may be promoted outside or off of social-networking system 2360, where appropriate. In particular embodiments, a page may be an on-line presence (such as a webpage or website within or outside of social-networking system 2360) of a business, organization, or brand facilitating its sharing of stories and connecting with people. A page may be customized, for example, by adding applications, posting stories, or hosting events.

A sponsored story may be generated from stories in users' news feeds and promoted to specific areas within displays of users' web browsers when viewing a web page associated with social-networking system 2360. Sponsored stories are more likely to be viewed by users, at least in part because sponsored stories generally involve interactions or suggestions by the users' friends, fan pages, or other connections. In connection with sponsored stories, particular embodiments may utilize one or more systems, components, elements, functions, methods, operations, or steps disclosed in U.S. patent application Ser. No. 13/327,557, entitled “Sponsored Stories Unit Creation from Organic Activity Stream” and filed 15 Dec. 2011, U.S. Patent Application Publication No. 2012/0203831, entitled “Sponsored Stories Unit Creation from Organic Activity Stream” and filed 3 Feb. 2012 as U.S. patent application Ser. No. 13/020,745, or U.S. Patent Application Publication No. 2012/0233009, entitled “Endorsement Subscriptions for Sponsored Stories” and filed 9 Mar. 2011 as U.S. patent application Ser. No. 13/044,506, which are all incorporated herein by reference as an example and not by way of limitation. In particular embodiments, sponsored stories may utilize computer-vision algorithms to detect products in uploaded images or photos lacking an explicit connection to an advertiser as disclosed in U.S. patent application Ser. No. 13/212,356, entitled “Computer-Vision Content Detection for Sponsored Stories” and filed 18 Aug. 2011, which is incorporated herein by reference as an example and not by way of limitation.

As described above, an advertisement may be text (which may be HTML-linked), one or more images (which may be HTML-linked), one or more videos, audio, other suitable digital object files, a suitable combination of these, or any other suitable advertisement in any suitable digital format. In particular embodiments, an advertisement may be requested for display within third-party webpages, social-networking-system webpages, or other pages. An advertisement may be displayed in a dedicated portion of a page, such as in a banner area at the top of the page, in a column at the side of the page, in a GUI of the page, in a pop-up window, over the top of content of the page, or elsewhere with respect to the page. In addition or as an alternative, an advertisement may be displayed within an application or within a game. An advertisement may be displayed within dedicated pages, requiring the user to interact with or watch the advertisement before the user may access a page, utilize an application, or play a game. The user may, for example view the advertisement through a web browser.

A user may interact with an advertisement in any suitable manner. The user may click or otherwise select the advertisement, and the advertisement may direct the user (or a browser or other application being used by the user) to a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). In particular embodiments, an advertisement may include one or more games, which a user or other application may play in connection with the advertisement. An advertisement may include functionality for responding to a poll or question in the advertisement.

An advertisement may include social-networking-system functionality that a user may interact with. For example, an advertisement may enable a user to “like” or otherwise endorse the advertisement by selecting an icon or link associated with endorsement. Similarly, a user may share the advertisement with another user (e.g., through social-networking system 2360) or RSVP (e.g., through social-networking system 2360) to an event associated with the advertisement. In addition or as an alternative, an advertisement may include social-networking-system content directed to the user. For example, an advertisement may display information about a friend of the user within social-networking system 2360 who has taken an action associated with the subject matter of the advertisement.

Social-networking-system functionality or content may be associated with an advertisement in any suitable manner. For example, an advertising system (which may include hardware, software, or both for receiving bids for advertisements and selecting advertisements in response) may retrieve social-networking functionality or content from social-networking system 2360 and incorporate the retrieved social-networking functionality or content into the advertisement before serving the advertisement to a user. Examples of selecting and providing social-networking-system functionality or content with an advertisement are disclosed in U.S. Patent Application Publication No. 2012/0084160, entitled “Providing Social Endorsements with Online Advertising” and filed 5 Oct. 2010 as U.S. patent application Ser. No. 12/898,662, and in U.S. Patent Application Publication No. 2012/0232998, entitled “Selecting Social Endorsement Information for an Advertisement for Display to a Viewing User” and filed 8 Mar. 2011 as U.S. patent application Ser. No. 13/043,424, which are both incorporated herein by reference as examples only and not by way of limitation. Interacting with an advertisement that is associated with social-networking-system functionality or content may cause information about the interaction to be displayed in a profile page of the user in social-networking-system 2360.

Particular embodiments may facilitate the delivery of advertisements to users that are more likely to find the advertisements more relevant or useful. For example, an advertiser may realize higher conversion rates (and therefore higher return on investment (ROI) from advertising) by identifying and targeting users that are more likely to find its advertisements more relevant or useful. The advertiser may use user-profile information in social-networking system 2360 to identify those users. In addition or as an alternative, social-networking system 2360 may use user-profile information in social-networking system 2360 to identify those users for the advertiser. As examples and not by way of limitation, particular embodiments may target users with the following: invitations or suggestions of events; suggestions regarding coupons, deals, or wish-list items; suggestions regarding friends' life events; suggestions regarding groups; advertisements; or social advertisements. Such targeting may occur, where appropriate, on or within social-networking system 2360, off or outside of social-networking system 2360, or on mobile computing devices of users. When on or within social-networking system 2360, such targeting may be directed to users' news feeds, search results, e-mail or other in-boxes, or notifications channels or may appear in particular area of web pages of social-networking system 2360, such as a right-hand side of a web page in a concierge or grouper area (which may group along a right-hand rail advertisements associated with the same concept, node, or object) or a network-ego area (which may be based on what a user is viewing on the web page and a current news feed of the user). When off or outside of social-networking system 2360, such targeting may be provided through a third-party website, e.g., involving an ad exchange or a social plug-in. When on a mobile computing device of a user, such targeting may be provided through push notifications to the mobile computing device.

Targeting criteria used to identify and target users may include explicit, stated user interests on social-networking system 2360 or explicit connections of a user to a node, object, entity, brand, or page on social-networking system 2360. In addition or as an alternative, such targeting criteria may include implicit or inferred user interests or connections (which may include analyzing a user's history, demographic, social or other activities, friends' social or other activities, subscriptions, or any of the preceding of other users similar to the user (based, e.g., on shared interests, connections, or events)). Particular embodiments may utilize platform targeting, which may involve platform and “like” impression data; contextual signals (e.g., “Who is viewing now or has viewed recently the page for [third-party brand]?”); light-weight connections (e.g., “check-ins”); connection lookalikes; fans; extracted keywords; EMU advertising; inferential advertising; coefficients, affinities, or other social-graph information; friends-of-friends connections; pinning or boosting; deals; polls; household income, social clusters or groups; products detected in images or other media; social- or open-graph edge types; geo-prediction; views of profile or pages; status updates or other user posts (analysis of which may involve natural-language processing or keyword extraction); events information; or collaborative filtering. Identifying and targeting users may also include privacy settings (such as user opt-outs), data hashing, or data anonymization, as appropriate.

To target users with advertisements, particular embodiments may utilize one or more systems, components, elements, functions, methods, operations, or steps disclosed in the following, which are all incorporated herein by reference as examples and not by way of limitation: U.S. Patent Application Publication No. 2009/0119167, entitled “Social Advertisements and Other Informational Messages on a Social Networking Website and Advertising Model for Same” and filed 18 Aug. 2008 as U.S. patent application Ser. No. 12/193,702; U.S. Patent Application Publication No. 2009/0070219, entitled “Targeting Advertisements in a Social Network” and filed 20 Aug. 2008 as U.S. patent application Ser. No. 12/195,321; U.S. Patent Application Publication No. 2012/0158501, entitled “Targeting Social Advertising to Friends of Users Who Have Interacted With an Object Associated with the Advertising” and filed 15 Dec. 2010 as U.S. patent application Ser. No. 12/968,786; or U.S. Patent Application Publication No. 2012/0166532, entitled “Contextually Relevant Affinity Prediction in a Social-Networking System” and filed 23 Dec. 2010 as U.S. patent application Ser. No. 12/978,265.

An advertisement may be presented or otherwise delivered using plug-ins for web browsers or other applications, iframe elements, news feeds, tickers, notifications (which may include, for example, e-mail, Short Message Service (SMS) messages, or notifications), or other means. An advertisement may be presented or otherwise delivered to a user on a mobile or other computing device of the user. In connection with delivering advertisements, particular embodiments may utilize one or more systems, components, elements, functions, methods, operations, or steps disclosed in the following, which are all incorporated herein by reference as examples and not by way of limitation: U.S. Patent Application Publication No. 2012/0159635, entitled “Comment Plug-In for Third-Party System” and filed 15 Dec. 2010 as U.S. patent application Ser. No. 12/969,368; U.S. Patent Application Publication No. 2012/0158753, entitled “Comment Ordering System” and filed 15 Dec. 2010 as U.S. patent application Ser. No. 12/969,408; U.S. Pat. No. 7,669,123, entitled “Dynamically Providing a News Feed About a User of a Social Network” and filed 11 Aug. 2006 as U.S. patent application Ser. No. 11/503,242; U.S. Pat. No. 8,402,094, entitled “Providing a Newsfeed Based on User Affinity for Entities and Monitored Actions in a Social Network Environment” and filed 11 Aug. 2006 as U.S. patent application Ser. No. 11/503,093; U.S. Patent Application Publication No. 2012/0072428, entitled “Action Clustering for News Feeds” and filed 16 Sep. 2010 as U.S. patent application Ser. No. 12/884,010; U.S. Patent Application Publication No. 2011/0004692, entitled “Gathering Information about Connections in a Social Networking Service” and filed 1 Jul. 2009 as U.S. patent application Ser. No. 12/496,606; U.S. Patent Application Publication No. 2008/0065701, entitled “Method and System for Tracking Changes to User Content in an Online Social Network” and filed 12 Sep. 2006 as U.S. patent application Ser. No. 11/531,154; U.S. Patent Application Publication No. 2008/0065604, entitled “Feeding Updates to Landing Pages of Users of an Online Social Network from External Sources” and filed 17 Jan. 2007 as U.S. patent application Ser. No. 11/624,088; U.S. Pat. No. 8,244,848, entitled “Integrated Social-Network Environment” and filed 19 Apr. 2010 as U.S. patent application Ser. No. 12/763,171; U.S. Patent Application Publication No. 2011/0083101, entitled “Sharing of Location-Based Content Item in Social-Networking Service” and filed 6 Oct. 2009 as U.S. patent application Ser. No. 12/574,614; U.S. Pat. No. 8,150,844, entitled “Location Ranking Using Social-Graph Information” and filed 18 Aug. 2010 as U.S. patent application Ser. No. 12/858,718; U.S. patent application Ser. No. 13/051,286, entitled “Sending Notifications to Users Based on Users' Notification Tolerance Levels” and filed 18 Mar. 2011; U.S. patent application Ser. No. 13/096,184, entitled “Managing Notifications Pushed to User Devices” and filed 28 Apr. 2011; U.S. patent application Ser. No. 13/276,248, entitled “Platform-Specific Notification Delivery Channel” and filed 18 Oct. 2011; or U.S. Patent Application Publication No. 2012/0197709, entitled “Mobile Advertisement with Social Component for Geo-Social Networking System” and filed 1 Feb. 2011 as U.S. patent application Ser. No. 13/019,061. Although this disclosure describes or illustrates particular advertisements being delivered in particular ways and in connection with particular content, this disclosure contemplates any suitable advertisements delivered in any suitable ways and in connection with any suitable content.

### Social Graph Affinity and Coefficient

In particular embodiments, social-networking system 2360 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 2370 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 2360 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 2360 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 2360 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 2360 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 2360 may calculate a coefficient based on a user's actions. Social-networking system 2360 may monitor such actions on the online social network, on a third-party system 2370, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 2360 may calculate a coefficient based on the user's actions with particular types of content. The content may be associated with the online social network, a third-party system 2370, or another suitable system. The content may include users, profile pages, posts, news stories, headlines, instant messages, chat room conversations, emails, advertisements, pictures, video, music, other suitable objects, or any combination thereof. Social-networking system 2360 may analyze a user's actions to determine whether one or more of the actions indicate an affinity for subject matter, content, other users, and so forth. As an example and not by way of limitation, if a user frequently posts content related to “coffee” or variants thereof, social-networking system 2360 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 2360 may calculate a coefficient based on the type of relationship between particular objects. Referencing the social graph 2400, social-networking system 2360 may analyze the number and/or type of edges 2406 connecting particular user nodes 2402 and concept nodes 2404 when calculating a coefficient. As an example and not by way of limitation, user nodes 2402 that are connected by a spouse-type edge (representing that the two users are married) may be assigned a higher coefficient than a user nodes 2402 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in a first photo, but merely likes a second photo, social-networking system 2360 may determine that the user has a higher coefficient with respect to the first photo than the second photo because having a tagged-in-type relationship with content may be assigned a higher weight and/or rating than having a like-type relationship with content. In particular embodiments, social-networking system 2360 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 2360 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 2400. As an example and not by way of limitation, social-graph entities that are closer in the social graph 2400 (i.e., fewer degrees of separation) may have a higher coefficient than entities that are further apart in the social graph 2400.

In particular embodiments, social-networking system 2360 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 2330 of the user). A first user may be more interested in other users or concepts that are closer to the first user. As an example and not by way of limitation, if a user is one mile from an airport and two miles from a gas station, social-networking system 2360 may determine that the user has a higher coefficient for the airport than the gas station based on the proximity of the airport to the user.

In particular embodiments, social-networking system 2360 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 2360 may provide information that is relevant to user's interests and current circumstances, increasing the likelihood that they will find such information of interest. In particular embodiments, social-networking system 2360 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 2360 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 2360 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 2370 (e.g., via an API or other communication channel), or from another suitable system. In response to the request, social-networking system 2360 may calculate the coefficient (or access the coefficient information if it has previously been calculated and stored). In particular embodiments, social-networking system 2360 may measure an affinity with respect to a particular process. Different processes (both internal and external to the online social network) may request a coefficient for a particular object or set of objects. Social-networking system 2360 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

### Privacy

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 2404 corresponding to a particular photo may have a privacy setting specifying that the photo may only be accessed by users tagged in the photo and their friends. In particular embodiments, privacy settings may allow users to opt in or opt out of having their actions logged by social-networking system 2360 or shared with other systems (e.g., third-party system 2370). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 2370, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers 2362 may be authorization/privacy servers for enforcing privacy settings. In response to a request from a user (or other entity) for a particular object stored in a data store 2364, social-networking system 2360 may send a request to the data store 2364 for the object. The request may identify the user associated with the request and may only be sent to the user (or a client system 2330 of the user) if the authorization server determines that the user is authorized to access the object based on the privacy settings associated with the object. If the requesting user is not authorized to access the object, the authorization server may prevent the requested object from being retrieved from the data store 2364, or may prevent the requested object from being sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

### Systems and Methods

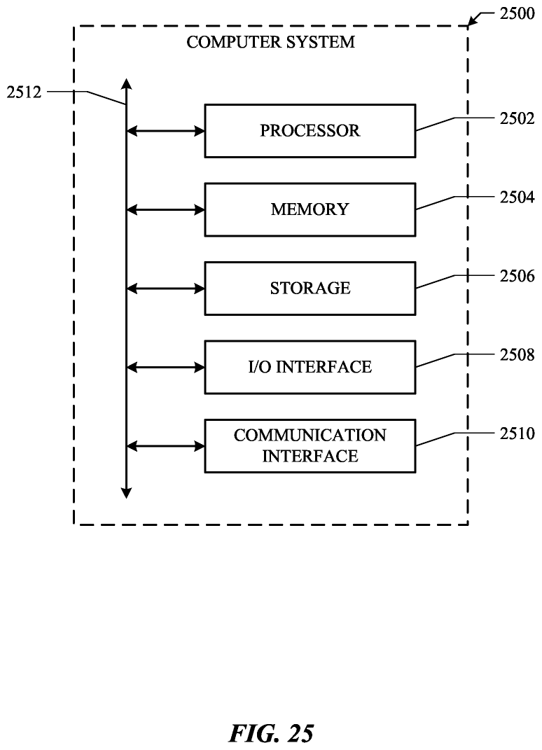

FIG. 25 illustrates an example computer system 2500. In particular embodiments, one or more computer systems 2500 perform one or more steps of one or more methods described or illustrated herein. In particular embodiments, one or more computer systems 2500 provide functionality described or illustrated herein. In particular embodiments, software running on one or more computer systems 2500 performs one or more steps of one or more methods described or illustrated herein or provides functionality described or illustrated herein. Particular embodiments include one or more portions of one or more computer systems 2500. Herein, reference to a computer system may encompass a computing device, and vice versa, where appropriate. Moreover, reference to a computer system may encompass one or more computer systems, where appropriate.

This disclosure contemplates any suitable number of computer systems 2500. This disclosure contemplates computer system 2500 taking any suitable physical form. As example and not by way of limitation, computer system 2500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 2500 may include one or more computer systems 2500; be unitary or distributed; span multiple locations; span multiple machines; span multiple data centers; or reside in a cloud, which may include one or more cloud components in one or more networks. Where appropriate, one or more computer systems 2500 may perform without substantial spatial or temporal limitation one or more steps of one or more methods described or illustrated herein. As an example and not by way of limitation, one or more computer systems 2500 may perform in real time or in batch mode one or more steps of one or more methods described or illustrated herein. One or more computer systems 2500 may perform at different times or at different locations one or more steps of one or more methods described or illustrated herein, where appropriate.

In particular embodiments, computer system 2500 includes a processor 2502, memory 2504, storage 2506, an input/output (I/O) interface 2508, a communication interface 2510, and a bus 2512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 2502 includes hardware for executing instructions, such as those making up a computer program. As an example and not by way of limitation, to execute instructions, processor 2502 may retrieve (or fetch) the instructions from an internal register, an internal cache, memory 2504, or storage 2506; decode and execute them; and then write one or more results to an internal register, an internal cache, memory 2504, or storage 2506. In particular embodiments, processor 2502 may include one or more internal caches for data, instructions, or addresses. This disclosure contemplates processor 2502 including any suitable number of any suitable internal caches, where appropriate. As an example and not by way of limitation, processor 2502 may include one or more instruction caches, one or more data caches, and one or more translation lookaside buffers (TLBs). Instructions in the instruction caches may be copies of instructions in memory 2504 or storage 2506, and the instruction caches may speed up retrieval of those instructions by processor 2502. Data in the data caches may be copies of data in memory 2504 or storage 2506 for instructions executing at processor 2502 to operate on; the results of previous instructions executed at processor 2502 for access by subsequent instructions executing at processor 2502 or for writing to memory 2504 or storage 2506; or other suitable data. The data caches may speed up read or write operations by processor 2502. The TLBs may speed up virtual-address translation for processor 2502. In particular embodiments, processor 2502 may include one or more internal registers for data, instructions, or addresses. This disclosure contemplates processor 2502 including any suitable number of any suitable internal registers, where appropriate. Where appropriate, processor 2502 may include one or more arithmetic logic units (ALUs); be a multi-core processor; or include one or more processors 2502. Although this disclosure describes and illustrates a particular processor, this disclosure contemplates any suitable processor.

In particular embodiments, memory 2504 includes main memory for storing instructions for processor 2502 to execute or data for processor 2502 to operate on. As an example and not by way of limitation, computer system 2500 may load instructions from storage 2506 or another source (such as, for example, another computer system 2500) to memory 2504. Processor 2502 may then load the instructions from memory 2504 to an internal register or internal cache. To execute the instructions, processor 2502 may retrieve the instructions from the internal register or internal cache and decode them. During or after execution of the instructions, processor 2502 may write one or more results (which may be intermediate or final results) to the internal register or internal cache. Processor 2502 may then write one or more of those results to memory 2504. In particular embodiments, processor 2502 executes only instructions in one or more internal registers or internal caches or in memory 2504 (as opposed to storage 2506 or elsewhere) and operates only on data in one or more internal registers or internal caches or in memory 2504 (as opposed to storage 2506 or elsewhere). One or more memory buses (which may each include an address bus and a data bus) may couple processor 2502 to memory 2504. Bus 2512 may include one or more memory buses, as described below. In particular embodiments, one or more memory management units (MMUs) reside between processor 2502 and memory 2504 and facilitate accesses to memory 2504 requested by processor 2502. In particular embodiments, memory 2504 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 2504 may include one or more memories 2504, where appropriate. Although this disclosure describes and illustrates particular memory, this disclosure contemplates any suitable memory.

In particular embodiments, storage 2506 includes mass storage for data or instructions. As an example and not by way of limitation, storage 2506 may include a hard disk drive (HDD), a floppy disk drive, flash memory, an optical disc, a magneto-optical disc, magnetic tape, or a Universal Serial Bus (USB) drive or a combination of two or more of these. Storage 2506 may include removable or non-removable (or fixed) media, where appropriate. Storage 2506 may be internal or external to computer system 2500, where appropriate. In particular embodiments, storage 2506 is non-volatile, solid-state memory. In particular embodiments, storage 2506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 2506 taking any suitable physical form. Storage 2506 may include one or more storage control units facilitating communication between processor 2502 and storage 2506, where appropriate. Where appropriate, storage 2506 may include one or more storages 2506. Although this disclosure describes and illustrates particular storage, this disclosure contemplates any suitable storage.

In particular embodiments, I/O interface 2508 includes hardware, software, or both, providing one or more interfaces for communication between computer system 2500 and one or more I/O devices. Computer system 2500 may include one or more of these I/O devices, where appropriate. One or more of these I/O devices may enable communication between a person and computer system 2500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 2508 for them. Where appropriate, I/O interface 2508 may include one or more device or software drivers enabling processor 2502 to drive one or more of these I/O devices. I/O interface 2508 may include one or more I/O interfaces 2508, where appropriate. Although this disclosure describes and illustrates a particular I/O interface, this disclosure contemplates any suitable I/O interface.

In particular embodiments, communication interface 2510 includes hardware, software, or both providing one or more interfaces for communication (such as, for example, packet-based communication) between computer system 2500 and one or more other computer systems 2500 or one or more networks. As an example and not by way of limitation, communication interface 2510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 2510 for it. As an example and not by way of limitation, computer system 2500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 2500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 2500 may include any suitable communication interface 2510 for any of these networks, where appropriate. Communication interface 2510 may include one or more communication interfaces 2510, where appropriate. Although this disclosure describes and illustrates a particular communication interface, this disclosure contemplates any suitable communication interface.

In particular embodiments, bus 2512 includes hardware, software, or both coupling components of computer system 2500 to each other. As an example and not by way of limitation, bus 2512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 2512 may include one or more buses 2512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method, comprising:
receiving, by a computing device of a user, a video data stream from a second computing device;
selecting one or more regions in at least one frame of the video data stream based on at least one of a focus point identified in the frame, a face identified in the frame, or a foreground identified in the frame;
determining a variable sampling rate based on a rate of change of objects in the video data stream;
generating sampling data by sampling the selected one or more regions of the frame at the variable sampling rate;
calculating a video quality metric by processing the sampling data using a machine learning model, the video quality metric corresponding to a video quality of the video data stream; and
adjusting the video quality of the video data stream based on the video quality metric.

2. A method comprising, by one or more computing systems:
retrieving a video;
detecting one or more moving regions of interest (ROIs);
tagging each of the ROIs with metadata configured to allow users to interact with the ROI;
storing the detected one or more ROIs and their corresponding metadata in a file;
synchronizing, based on the file, playback of the video and movement of the one or more ROIs;
receiving, from a client device of a user, user selection of a first ROI from among the one or more ROIs;
retrieving content associated with the first ROI based on the tagged metadata of the first ROI; and
sending, to the client system, instructions to present the retrieved content.
